(19) United States
(12) Patent Application Publication
(10) Pub. No.: US 2008/0076387 A1
(43) Pub. Date: Mar. 27, 2008

(54) SYSTEM AND METHOD FOR ROUTING COMMUNCIATIONS USING CONTEXT INFORMATION

(75) Inventors: Samuel M. Levenson, Arlington Heights, IL (US); Paul M. Bocci, Roselle, IL (US); Richard H. Noens, Palatine, IL (US); Anand Sampath, Corona, CA (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/534,357

(22) Filed: Sep. 22, 2006

(51) Int. Cl. H04M 1/66

(52) U.S. Cl. 455/411

(57) ABSTRACT

A context (112) of a communication received from a user in a vehicle is determined. The context (112) relates to a characteristic associated with the vehicle. An address of the communication is formed based upon the context (112) of the communication received from the user in the vehicle. The communication is transmitted to a recipient using the address.

### FIELD OF THE INVENTION

The field of the invention relates routing communications through networks and, more specifically, to generating addresses in order to route communications through these networks.

### BACKGROUND OF THE INVENTION

Various types of mobile stations are utilized by users in today's communication networks. For example, users often operate their cellular phones from their vehicle while traveling in the vehicle. In another example, a user may utilize a pager while traveling, at the office, or at home. In order to allow communications to be made, various infrastructure elements such as switches, servers, or the like are provided by the network.

When communicating with recipients, senders of communications often have various concerns and requirements. For instance, some senders are concerned about their privacy and do not desire their identity-related information (e.g., names and phone numbers) revealed to recipients. Specifically, some users do not want their identity known when calling a recipient because they fear that the information may be lost, mishandled, or misused.

Another concern with users is that the communication should be accurately transmitted to the intended recipient or recipients. For example, users typically do not want their communications to be transmitted to unintended recipients.

Previous systems embedded an address in the communication and routed the communication to the recipient based upon the address. Unfortunately, this previous approach does not take into account the privacy concerns of the user since the address is related to the sender's identity and, consequently, the sender's identity is revealed to or can be easily determined by the recipient. Hard-coding the address into a message is also not a very flexible or efficient addressing approach since the address will typically depend upon, among other things, the underlying technology of the system.

### BRIEF DESCRIPTION OF THE DRAWINGS

The above needs are at least partially met through provision of a system and method for routing and addressing communications by context as described in the following detailed description, particularly when studied in conjunction with the drawings, wherein:

FIG. 1 is a block diagram of one example of a system for addressing a communication according to context according to various embodiments of the present invention;

FIG. 2 is a flow chart of one example of an approach for determining an address for communications according to various embodiments of the present invention;

FIG. 3 is a block diagram of one example of an approach for applying a context to a communication to generate an address according to various embodiments of the present invention;

FIG. 4 is a block diagram of another example of an approach for applying a context to a communication to generate an address according to various embodiments of the present invention; and

FIG. 5 is a block diagram of a device for addressing communications according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method are provided that dynamically determine an address for a communication based upon the context of the communication. By generating an address based upon the context, the address generated does not uniquely identify the sender and, consequently, the sender can remain anonymous to the recipient. In addition, the context of the sender may be more meaningful than the identity of the sender. Consequently, the approaches described herein are also flexible and efficient, can be applied to systems with different underlying technologies, and accurately deliver the communication to the intended recipients.

In many of these embodiments, a context of a communication received from a source associated with a vehicle operating environment is determined. The vehicle operating environment may relate to any location associated with conducting, controlling, or evaluating vehicular traffic such as roadways, parking lots, or traffic control centers. Other examples of vehicular operating environments are possible. The context relates to a characteristic associated with a vehicle. An address of the communication is formed based upon the context of the received communication. The communication is then transmitted to a destination using the address.

The source and destination may be, to give two examples, users in vehicles or associated with the traffic infrastructure (e.g., a switch or call control center within the infrastructure). The communication may be from the person (e.g., using an electronic communication device), from a system or subsystem of a vehicle, from a device associated with the vehicle, or from a device carried by a user of the vehicle. Consequently, the present approaches allow communications to be sent from a user in a vehicle to the infrastructure, from the infrastructure and a user in a vehicle, or between users in vehicles.

Preferably, the address does not identify the source (e.g., user in a vehicle) to the destination (e.g., recipient) of the communication. The address may be of any type and relate to any addressing layer when layered protocols are used. In this regard, the address may be an application layer address, an Internet Protocol (IP) layer address, or an Ethernet address. Other examples of addresses are possible. In still other examples, the address may relate to or identify the context. For instance, the address may identify the context as being sent from a vehicle of a certain model or type.

The context may relate to one or more attributes and these attributes may be static, dynamic, or a combination of static and dynamic. For example, the context may be a dynamic attribute such as vehicle location, a vehicle speed, a time of day, a vehicle status, an acceleration of the vehicle, or a vehicle heading. In other examples, the context may be a static attribute such as vehicle model or type. In yet another example, the context may be a combination of static and dynamic attributes such as vehicle model and vehicle location. Other examples of attributes and combinations of these attributes are possible.

The communication sent to the recipient may, if the sender desires, include additional information. For example, a unique identifier may be added to the communication and the unique identifier may identify the sender and/or the recipient.

Thus, approaches are described that allow for addressing to be accomplished according to context that ensures that identity-related attributes of a sender remain anonymous to a recipient. The approaches are flexible to use and allow for the efficient use of system resources.

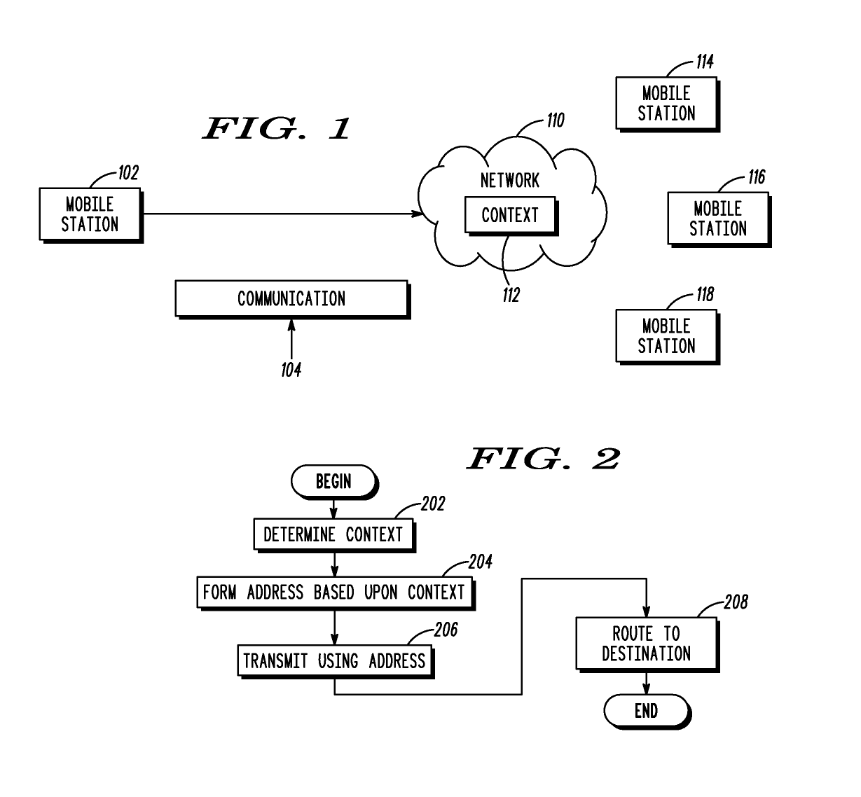

Referring now to FIG. 1, one example of a system for addressing a communication according to context is described. A user at a first mobile station 102 sends a communication 104. The communication 104 is received by a network 110. Based upon information conveyed in the communication 104, the network 110 determines the context for the communication and uses the context to create an address. The address is used by the network 110 to route the communication to one or more recipients, for example, to one or more mobile stations 114, 116, and 118.

The network 110 may be any type of network that is used to route information. In this regard, it may be a packet data network, the Internet, a Public Switched Telephone Network, a wireless network, or some combination of these networks. Other examples and other combinations of these networks are possible. The network 110 may include various components. For instance, the network 110 may include switches, servers, and gateways. In another example, the network 110 may include different sub-networks such as a Radio Access Network (RAN).

The mobile stations 102, 114, 116, and 118 may be any type of portable electronic device. For example, the mobile stations 102, 114, 116, and 118 may be cellular phones, pagers, personal digital assistants, embedded vehicle systems, or personal computers. Other examples of mobile stations are possible.

The context 112 may be one or more attributes that are used to form an address (e.g., by applying a rule to the context). In this regard, the context 112 may be related to the sender. For example, the context 112 may be related to the sender's identity, the type of information being transmitted, or a characteristic of a vehicle in which the sender is traveling. Other examples of contexts related to the sender are possible.

The context 112 may also be related to the recipient(s). For example, the context 112 may be all vehicles traveling at a certain speed or at a certain location. In another example, the context 112 may be all vehicles of a certain type or a user identity. Other examples of contexts related to the recipient are possible.

The address may be of any type and relate to any protocol, aspect of any protocol, or layer of any layered protocol. In this regard, the address may be an application layer address, an Internet Protocol (IP) layer address, or an Ethernet address. Other examples of addresses are possible. In still other examples, the address may relate to or identify the context. For instance, the address may identify the context as that of being sent from a vehicle of a certain type (e.g., model) that is traveling at a certain location (e.g., on a certain road or section of road).

The address may be a source or destination address. In addition, the address may be resolved as required by a routing protocol. For example, if the address is a source address and the messages sent include a destination address, in some protocols, the source address need not be resolved to any routing information. In other protocols, the source address can be resolved.

The context 112 may relate to one or more attributes that are static, dynamic, or a combination of static and dynamic. For example, the context 112 may relate to a dynamic attribute such as vehicle location, vehicle speed, time of day, acceleration of the vehicle, a vehicle heading, or vehicle condition (e.g., operable or non-operable). In another example, the context 112 may be related to a static attribute such as vehicle type or model. In still another example, the context may relate to both dynamic and static attributes (vehicle heading, location, and type).

The communication 104 may, if the sender desires, include additional information. For example, a unique identifier may be added to the communication 104 and the unique identifier may identify at least one of the user and the recipient.

Referring now to FIG. 2, one example of an approach for determining an address for a communication using a context is described. As mentioned, the present approaches allow communications to be exchanged between any source and destination such as between a user in a vehicle and the infrastructure, between the infrastructure and a user in a vehicle, or between users in vehicles. Other examples of sources and destinations are possible.

At step 202, the context of a communication is determined. The context may be related to the context of the sender of the message, the recipient of the message, or some combination of these contexts. For instance, the context may relate to the type of message, the type of vehicle, or the identity of the sender. In another example, the context may relate to the location of vehicles (e.g., all vehicles on a certain portion of roadway or all vehicles traveling at a certain speed or a combination of both these factors). As mentioned elsewhere in this specification, the attributes may be static, dynamic, or a combination of static and dynamic. Other examples and combinations of context attributes are possible.

At step 204, an address may be formed to transmit the communication to the destination. This address may not identify the sender to the recipient. The address may be structured using any convenient address structure or address representation such as a binary number or pointer.

At step 206, the communication is transmitted to the recipient using the address. In one approach, the address may be sent with the communication. Alternatively, the system may identify the recipient and route the communication to the recipient using the address but without including the address in the communication. At step 208, the address is routed to and received at the destination.

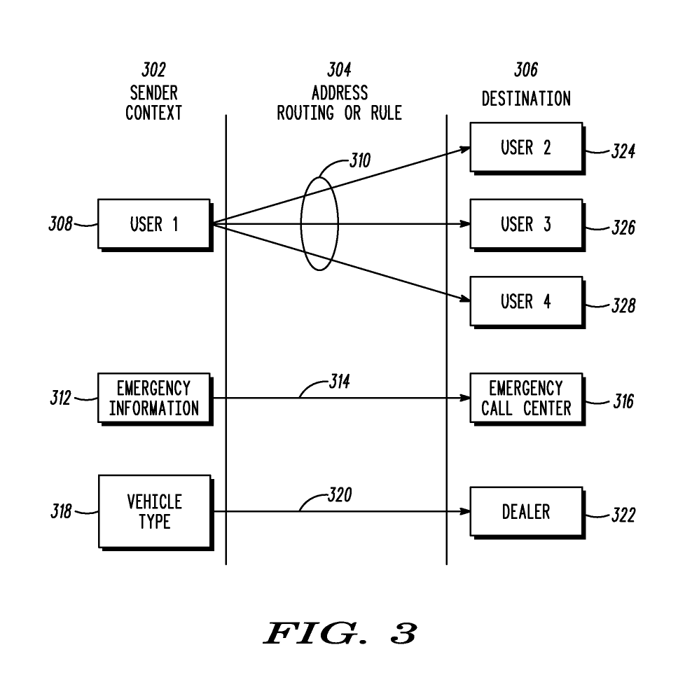

Referring now to FIG. 3, one example of an approach for applying a context to a communication in order to generate an address is described. In this example, the context relates to an attribute of the sender of the communication. The applicable recipient or recipients 306 are determined by applying a rule (or address routing) 304 to the context 302. In other words, the rules 304 (shown as pointers) determine for a particular context 302 a routing to one or more of the recipients 306.

In this example, a user 308 with identity (i.e., the context) “User 1” is routed by rules 310 to a second user 324 (“User 2”), a third user 326 (“User 3”), and a fourth user 328 (“User 4”). The “users” may be people, a system or subsystem of the vehicle, a device associated with the vehicle, a device carried by a user of the vehicle, or a communication infrastructure. In another example, a communication 312 that is identified as including emergency information (i.e., the context) is routed by rule 314 to an emergency call center 316. In still another example, a communication 318 with a context of “vehicle type A” is routed by rule 320 to an automobile dealer 322. The rule 304 may generate an actual address (e.g., a binary number or pointer) that is used by different network entities to deliver the communication to the destination. Alternatively, the rule 304 may instruct and/or cause various network entities to deliver the communication to the determined destination using any route (or combination of routes) without generating or including the address in the communication. The rule 304 may be in the form of any convenient data structure such as a pointer or table.

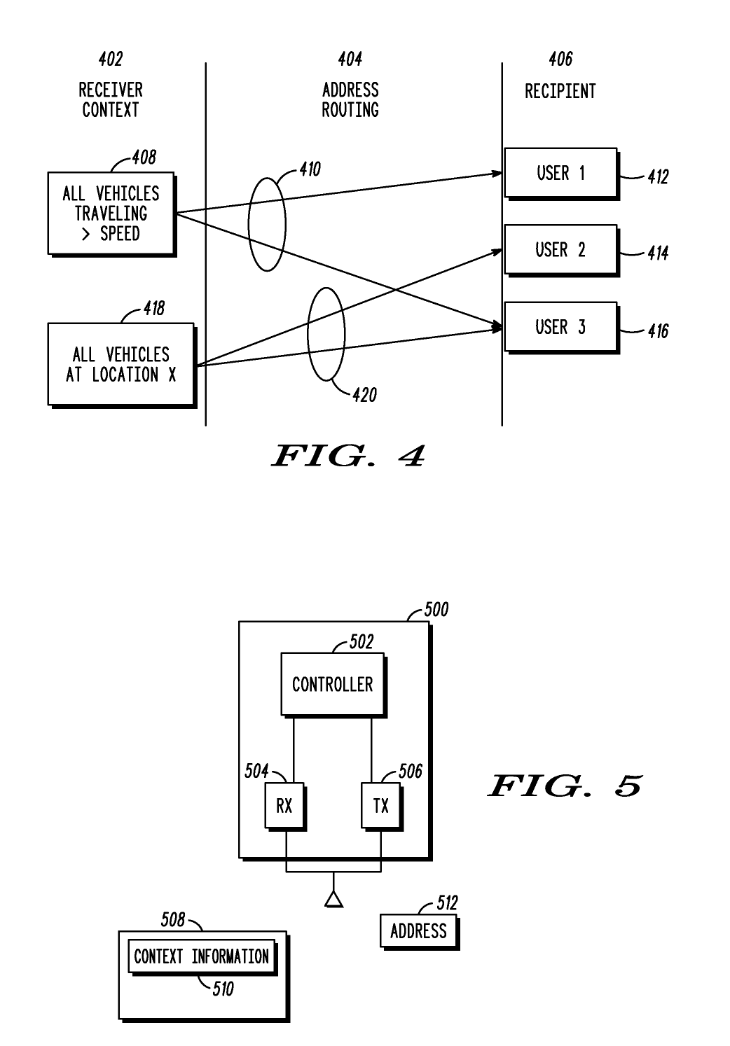

Referring now to FIG. 4, another example of an approach for applying a context to a communication in order to generate an address is described. In this example, the context relates to an attribute of the recipient(s) of the communication. The applicable recipient or recipients 406 are determined by applying a rule (or address routing) 404 to the context 402. In other words, the rules 404 (shown as pointers) determine for a particular context 402 a routing to one or more of the recipients 406.

In this example, communications 408 are routed to vehicles that are traveling greater than a certain speed (i.e., the context) by rule 410. In this case, the communications are routed to a first user 412 (“User 1”) and a third user 416 (“User 3”). In another example, communications 418 being made at a particular location (i.e., the context) are routed by rule 420. In this case, the rule 420 routes the communications 418 to a second user 414 (“User 2”) and the third user 416 (“User 3”). As with the example of FIG. 3, the rule 404 may generate an actual address that is used by different network entities to deliver the communication to the destination. Alternatively, the rule 404 may instruct network entities to deliver the communication to the determined destination using any route (or combination of routes) without generating or including the address. In addition, the rule 404 may be in the form of any convenient data structure such as a pointer or table.

Referring now to FIG. 5, one example of a device 500 used to generate an address that is based upon context is described. The device 500 includes a controller 502, a receiver 504, and a transmitter 506.

The receiver 504 receives a communication 508 from a user in a vehicle. The communication 508 includes a context 510 that is related to a vehicle. The controller 502 is programmed to form an address 512 of the communication by using the context 510 and to transmit the communication 508 to a recipient at the address 512 using the transmitter 506.

The context 510 may relate to a number of different characteristics or attributes. For example, the context 510 may relate to vehicle location, vehicle speed, time of day, vehicle status, acceleration of the vehicle, or vehicle heading. In addition, the context 510 may have dynamic attributes, static attributes, or both dynamic and static attributes.

Thus, approaches are described that allow for context-based addressing to be accomplished that ensures and ensures that identity-related attributes of a sender remain anonymous to a recipient. The approaches are flexible to use, efficiently use system resources, and accurately deliver communications to recipients.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of transmitting communications to a recipient comprising:
determining a context of a communication received from a source associated with a vehicle operating environment, the context related to a characteristic associated with a vehicle;
forming an address of the communication based upon the context of the communication received from the source; and
transmitting the communication to a destination using the address.

2. The method of claim 1 wherein the source and destination are chosen from a group comprising a user in a vehicle, a system or subsystem of a vehicle, a device associated with the vehicle, a device carried by a user of the vehicle and a communication infrastructure.

3. The method of claim 1 further comprising resolving the address as required by a routing protocol.

4. The method of claim 1 wherein determining a context comprises determining a characteristic selected from a group comprising: a vehicle location, a vehicle speed, a time of day, a vehicle status, and an acceleration of the vehicle.

5. The method of claim 1 wherein forming an address comprises forming the address such that the address does not identify the source to the destination of the communication.

6. The method of claim 1 wherein forming an address comprises forming an address selected from a group comprising an application layer address and an Internet Protocol (IP) layer address.

7. The method of claim 1 further comprising adding a unique identifier to the communication, the unique identifier identifying at least one of the source and the destination.

8. The method of claim 1 wherein forming an address comprises forming an address comprising information indicative of the context.

9. A method of routing a communication to at least one recipient comprising:
receiving a communication originated by a user in a vehicle, the communication containing an address, the address reflecting a context of the vehicle; and
resolving the address and routing the communication to at least one recipient such that an identity of the user at the vehicle remains unknown to the at least one recipient.

10. The method of claim 9 further comprising resolving the address as required by a routing protocol.

11. The method of claim 9 wherein receiving the communication comprises receiving a communication with a context, the context being a characteristic selected from a group comprising: a vehicle location, a vehicle speed, a time of day, a vehicle status, and an acceleration of the vehicle.

12. The method of claim 9 wherein receiving a communication with an address comprises receiving a communication with an address, the address being selected from a group comprising an application layer address and an Internet Protocol (IP) layer address.

13. A device for sending communications to recipients comprising:
a receiver for receiving a communication from a source associated with a vehicle operating environment, the communication having a context associated with a vehicle;
a transmitter; and
a controller coupled to the receiver and the transmitter, the controller programmed to form an address of the communication by using the context and to transmit the communication to a destination at the address using the transmitter.

14. The device of claim 13 wherein the source and destination are chosen from a group comprising a user in a vehicle, a system or subsystem of a vehicle, a device associated with the vehicle, a device carried by a user of the vehicle and a communication infrastructure.

15. The device of claim 13 wherein the controller is further programmed to resolve the address as required by a routing protocol.

16. The device of claim 12 wherein the context is a characteristic selected from a group comprising at least one of: a vehicle location, a vehicle speed, a time of day, a vehicle status, an acceleration of the vehicle, and a vehicle heading.

17. The device of claim 13 wherein the context is selected from a group comprising: a context having dynamic attributes, a context having dynamic and static attributes, and a context having static attributes.

18. The device of claim 13 wherein the address does not identify an identity of the source to a recipient of the communication.

19. The device of claim 13 wherein the address is selected from a group comprising an application layer address and an Internet protocol (IP) layer address.

20. The device of claim 13 wherein the communication includes a unique identifier identifying at least one of the source and the destination.
